(19) United States
(12) Patent Application Publication
(10) Pub. No.: US 2014/0054813 A1
(43) Pub. Date: Feb. 27, 2014

(54) POROUS FILM PRODUCTION METHOD AND DEVICE

(71) Applicant: Katsuhiko Shinada, Aichi (JP)

(72) Inventor: Katsuhiko Shinada, Aichi (JP)

(73) Assignee: MITSUBISHI RAYON CO., LTD., Tokyo (JP)

(21) Appl. No.: 14/112,239

(22) PCT Filed: Apr. 20, 2012
(86) PCT No.: PCT/JP2012/060747

§ 371 Date: Nov. 14, 2013

(30) Foreign Application Priority Data
Apr. 20, 2011 (JP) 2011-094286
May 12, 2011 (JP) 2011-107554

(51) Int. Cl. B29C 39/44

(52) U.S. Cl. CPC B29C 39/44
USPC 264/40.1; 264/41; 425/143

(57) ABSTRACT

A method for producing a porous film is described, including a solidification step for solidifying a film-forming starting solution in a solidification solution. In the method, the temperature of the solidification solution used in the solidification step is controlled by transferring the solidification solution, which is temperature-controlled by a temperature control means, to a solidification means for solidifying the film-forming starting solution. An apparatus for executing the method is also described. The method and apparatus for producing a porous film are capable of stably controlling the temperature of the solidification solution to control the fluctuation in the quality of the obtained porous film. In addition, an apparatus for producing a porous film, which is capable of producing a hollow-fiber film without causing defects thereto, is also described.

### BACKGROUND OF THE INVENTION

1. Field of the Invention

This invention relates to a method and an apparatus for producing a porous film.

This application claims the priority of Japan Patent Application No. 2011-094286 filed on Apr. 20, 2011 and Japan Patent Application No. 2011-107554 filed on May 12, 2011, disclosures of which are incorporated herein by reference.

2. Description of Related Art

In recent years, as the concern about environmental pollution is deepened and the restriction thereto is enhanced, methods that utilize porous hollow-fiber films featuring superior separation completeness and compactness have received much attention as water treatment methods.

In the food industry, the medical industry, the electronic industry and so on, microfiltration films, ultrafiltration films, reverse-osmosis filtering films or the like that adopt porous films are used in most cases for purposes of concentrating and recycling useful ingredients, removing undesired ingredients, fresh water generation, and so on.

As a method for producing a porous film, for example, the following method has been known. A film-forming starting solution containing a film-forming resin, a pore former and a solvent is discharged from a discharge means (a spinning nozzle, a T die or the like) and is solidified in a solidification solution to form a porous film, and then the porous film is cleaned and dried (Patent Document 1). In this method for producing a porous film, the temperature of the solidification solution is controlled to be a specified temperature to suppress the fluctuation in the quality.

As an apparatus for producing a porous film, generally the following apparatus is used. The apparatus includes a discharge means (a spinning nozzle, a T die or the like) for discharging the film-forming starting solution, and a solidification bath for receiving the solidification solution. The solidification solution solidifies the film-forming starting solution discharged from the discharge means to form a porous film, and warm water which has been temperature-controlled is circulated in a jacket portion of the solidification bath to control the temperature of the solidification solution in the solidification bath.

Further, as a method for producing a porous hollow-fiber film, a non-solvent induced phase separation (NIPS) method that utilizes the NIPS phenomenon has been known. The NIPS phenomenon refers to phase separation of a polymer solution by use of a non-solvent to achieve porosity. As the NIPS method, a wet spinning method and a dry-jet wet-spinning method (collectively termed as “the wet-spinning” hereinafter) are known. As a method for producing a porous hollow-fiber film through the wet-spinning, the following method has been known. A film-forming starting solution containing a hydrophobic polymer, a hydrophilic polymer and a solvent is prepared, discharged from a spinning nozzle and then solidified in a solidification solution to obtain a hollow fiber, and finally the hydrophilic polymer is removed to form a porous hollow-fiber film (Patent Documents 1 to 3).

### PRIOR ART DOCUMENTS

### Patent Documents

Patent Document 1: Japan Patent Publication No. 2006-231276
Patent Document 2: Japan Patent Publication No. 2008-126199
Patent Document 3: Japan Patent Publication No. 2010-142747

### SUMMARY OF THE INVENTION

### Problem to be Solved by the Invention

However, when the aforesaid production apparatus is used, there may be quality variation between the porous film obtained at the beginning of the spinning process and that obtained at the end of the spinning process.

For the method disclosed in Patent Document 1, sometimes defects may be found on the porous film obtained. As a result of a research on how such defects are induced, this inventor has found that the defects are induced on the porous film by foreign matters such as the detached polymer residues that make contact with the solidified porous film in the solidification tank.

In view of this, an object of this invention is to provide a porous film production apparatus capable of preventing contact of the foreign matters with the porous film in the solidification tank.

Further, in terms of the fluctuation in the quality of the porous film, the present inventor has conducted research on the fluctuation of the solution temperature of the solidification solution with time. As a result, the following method has been found: by stably controlling the temperature of the solidification solution, a porous film production method and a porous film production apparatus capable of suppressing the fluctuation in the quality of the porous film can be provided. This invention is thus accomplished. An object of this invention is to provide a porous hollow-man film production method and a porous hollow-man film production apparatus capable of suppressing the fluctuation in the quality of the obtained porous hollow-fiber film.

### Means to Solve the Problem

The method and the apparatus for producing a porous film of this invention are as follows.

(1) A method for producing a porous film, comprising a solidification step for solidifying a film-forming starting solution in a solidification solution, wherein the temperature of the solidification solution used in the solidification step is controlled by transferring the solidification solution, which is temperature-controlled by a temperature control means, to a solidification means for solidifying the film-forming starting solution.

(2) The method of (1), wherein the temperature of the solidification solution is measured in a solidification bath for solidifying the film-forming starting solution in the solidification means, and the result of the measurement is fed back to control the temperature of the solidification solution in a solution-storing tank.

(3) The method of (1), wherein the solidification solution is drawn from the solidification means for solidifying the film-forming starting solution, and after the temperature of the solidification solution is controlled in the solution-storing tank, the solidification solution is returned back to the solidification means for recycling.

(4) The method of (3), wherein the solidification means is a solidification bath, and the amount of the solidification solution transferred from the temperature control means to the solidification tank means per minute is 30% to 70% of the solution amount stored in the solidification bath.

(5) The method of (4), wherein the solidification solution transferred from the temperature control means is transferred to the solidification bath via a pipe having an inner diameter of 10 mm to 30 mm.

(6) The method of (5), wherein the pipe has a length of 500 mm to 20000 mm.

(7) The method of (4), wherein the temperature of the liquid transferred from the temperature control means to the pipe is 1° C. to 5° C. higher than the temperature of the solidification bath.

(8) An apparatus for producing a porous film, comprising: a solidification means for solidifying a film-forming starting solution in a solidification solution; a supplying means for supplying the solidification solution to the solidification means; and a temperature control means for controlling the temperature of the solidification solution.

(9) The apparatus of (8), wherein the solidification means has a solidification bath for solidifying the film-forming starting solution, and a temperature measuring means for measuring the temperature of the solidification solution in the solidification bath, and the measurement result from the temperature measuring means is fed back so that the temperature of the solidification solution is controlled by the temperature control means.

(10) The apparatus of (8), wherein the solidification solution is drawn from the solidification means to a solution-storing tank, and after the temperature of the solidification solution is controlled in the solution-storing tank, the solidification solution is returned by the supplying means back to the solidification means for recycling.

(11) The apparatus of (8), comprising a filtering means disposed outside of the solidification bath to filter the solidification solution.

(12) The apparatus of (11), wherein in the solidification bath, a guide roll for guiding a hollow fiber obtained through solidifying the film-forming starting solution to outside of the solidification bath is disposed in a manner such that a part of the peripheral surface of the guide roll is immersed in the solidification solution while the remaining part of the peripheral surface is exposed above a liquid level of the solidification solution.

### Effects of the Present Invention

According to the method for producing a porous film of this invention, the temperature of the solidification solution can be stably controlled to suppress the fluctuation in the quality of the obtained porous film.

Further, by use of the apparatus for producing a porous film of this invention, the temperature of the solidification solution can be stably controlled to suppress the fluctuation in the quality of the obtained porous film.

The apparatus for producing a porous film of this invention can produce a porous film without any damage.

If a guide roll for guiding the obtained hollow fiber to the outside is disposed in the solidification tank in the apparatus for producing a porous film of this invention in a manner such that a part of the guide roll is immersed in the solidification solution, the cleaning load in the cleaning step at the downstream side can be eased and the peripheral surface of the guide roll can also be cleaned.

Further, if a cleaning tank for cleaning the obtained hollow fiber by means of a heated cleaning solution is included and the heated cleaning solution for cleaning is transferred to the solidification tank, exhaust of the used cleaning solution containing a high concentration of BOD (biochemical oxygen demand) can be reduced.

Further, if partitions for partitioning the interior of the cleaning tank into a plurality of compartments that allow for movement of the heated cleaning solution are provided in the cleaning tank so that the heated cleaning solution flows from the downstream side towards the upstream side in the transferring direction of the hollow fiber, the hollow fiber can be effectively cleaned by the heated cleaning solution.

Further, if a lower guide roll disposed below the liquid level of the heated cleaning solution of the cleaning tank and an upper guide roll disposed above the liquid level of the heated cleaning solution are provided in the apparatus for producing a porous film of this invention, the hollow fiber can be immersed into the heated cleaning solution repeatedly to further improve the cleanability of the hollow fiber.

If drive rolls for transferring the obtained hollow fiber and a drive roll cleaning means for discharging a good solvent of the hydrophilic polymer towards the drive rolls are provided in the apparatus for producing a porous film of this invention, the hollow fiber can be transferred smoothly.

According to the aspect of (1), a constant temperature of the solidification solution can be ensured irrespective of the seasonal changes, so the fluctuation in the quality can be suppressed.

According to the aspect of (2), the fluctuation in temperature can be suppressed.

According to the aspect of (3), an agitating effect attributed to the circulation is also obtained, so a more precise and uniform temperature control can be achieved.

According to the aspect of (4), the temperature in the tank can be controlled.

According to the aspect of (5), a good balance is achieved between the heat dissipation and the pressure loss.

According to the aspect of (6), a good balance is achieved between the heat dissipation and the pressure loss.

According to the aspect of (7), the temperature of the solidification solution in the pipe will not drop, so the temperature of the solidification solution can be controlled.

According to the aspect of (8), a constant temperature of the solidification solution can be ensured irrespective of the seasonal changes, so the fluctuation in the quality can be suppressed.

According to the aspect of (9), the fluctuation in temperature can be suppressed.

According to the aspect of (10), an agitating effect attributed to the circulation is also obtained, so a more precise and uniform temperature control can be achieved.

According to the aspect of (11), foreign matters can be removed to reduce damages to the porous hollow-fiber film.

According to the aspect of (12), the cleanability of the hollow-fiber film can be improved.

### BRIEF DESCRIPTION OF THE DRAWINGS

FIG. 1 is a schematic view illustrating an example of an apparatus for producing a porous film of this invention.

FIG. 2 is a schematic view illustrating an embodiment of an apparatus for producing a porous film of this invention.

FIG. 3 is a plan view illustrating a spinning nozzle that constitutes the porous film production apparatus shown in FIG. 2.

FIG. 4 is a top view illustrating a cleaning tank that constitutes the porous film production apparatus shown in FIG. 2.

### DESCRIPTION OF THE EMBODIMENTS

Hereinafter, a method and an apparatus for producing a porous hollow-fiber film will be illustrated and detailed as an example of the method and the apparatus for producing a porous film of this invention.

Furthermore, the “porous hollow-fiber film” as used in this invention refers to a hollow-fiber film having porous layers both on the surface and in the interior. Hereinafter, the “hollow-fiber film” refers to a “porous hollow-fiber film” unless otherwise stated. Moreover, as specific examples of the “porous film”, a “porous flat film” may also be used in addition to the “porous hollow-fiber film”.

The apparatus for producing a porous film of this invention comprises: a solidification means (also called a “solidification part”) for solidifying a film-forming starting solution in a solidification solution, a supplying means for supplying the solidification solution to the solidification means, a temperature control means for controlling the temperature of the solidification solution, a cleaning means (also called a “cleaning part”) for removing the solvent remaining in the porous film, a removing means (also called a “removing part”) for removing the pore former remaining in the porous film; a drying means (also called a “drying part”) for drying the porous film, and a winding means for winding the porous film.

### (Porous Hollow-Fiber Film Production Device I)

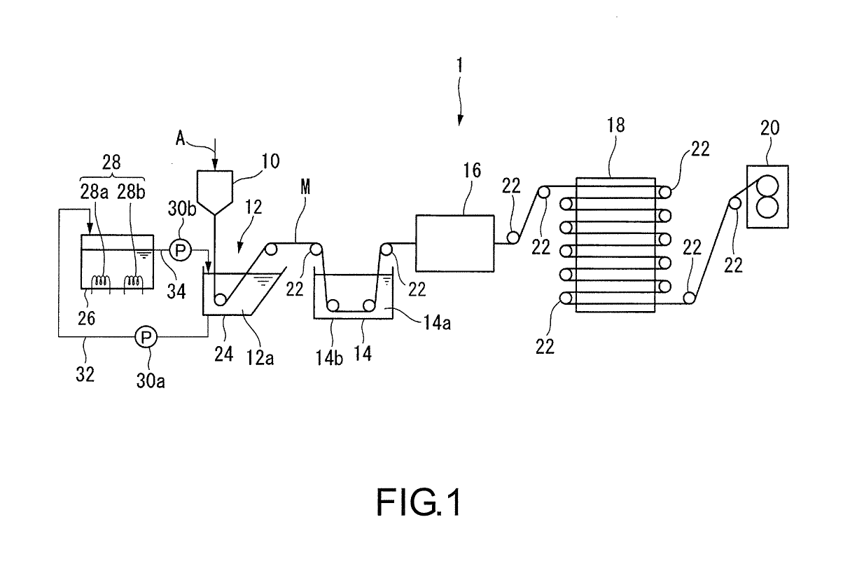

As shown in FIG. 1, the apparatus 1 for producing a porous hollow-fiber film of this embodiment comprises: a spinning nozzle 10 for spinning a film-forming starting solution A containing a film-forming resin, a pore former and a solvent, a solidification means 12 for solidifying the film-forming starting solution A in a solidification solution 12a to form a porous hollow-fiber film M, a cleaning means 14 for removing the solvent remaining in the porous hollow-fiber film M, a removing means 16 for removing the pore former remaining in the porous hollow-fiber film M, a drying means 18 for drying the porous hollow-fiber film M, a winding means 20 for winding the porous hollow-fiber film M, guiding members 22 for limiting the movement of the porous hollow-fiber film M in the production device 1, a solution-storing tank 26 for storing the solidification solution 12a transferred from the solidification means 12, a supplying means for supplying the solidification solution 12a to the solidification means 12, and a temperature control means 28 for controlling the temperature of the solidification solution 12a in the solution-storing tank 26.

The spinning nozzle 10 is a nozzle for spinning the film-forming starting solution A. As the spinning nozzle 10, a spinning nozzle typically used in production of a porous hollow-fiber film may be used. As implementations of the spinning nozzle 10, for example, an implementation in which only the film-forming starting solution A is discharged in a cylindrical form and an implementation in which a reinforcing hollow support passes through the nozzle so that the film-forming starting solution A is coated on the outer side of the reinforcing support for spinning purpose may be adopted. Moreover, the spinning nozzle 10 may be implemented either in a manner such that a single film-forming starting solution A is discharged to form a porous hollow-fiber film M having a single porous film layer or in a manner such that a plurality of film-forming starting solutions A are discharged concentrically to form a porous hollow-fiber film M in which multiple porous film layers are stacked.

Additionally, when a porous flat film is to be produced instead of this embodiment, a discharge means such as a conventional T die may be used instead of the spinning nozzle 10.

The solidification means 12 is used to solidify the film-forming starting solution A, which is spun by the spinning nozzle 10, by means of the solidification solution 12a. The solidification means 12 has a solidification bath 24 for receiving the solidification solution 12a and solidifying the film-forming starting solution A. After the film-forming starting solution A is solidified in the solidification solution 12a to form the porous hollow-fiber film M in the solidification means 12, the porous hollow-fiber film M is drawn from the solidification solution 12a.

The solidification bath 24 is connected with the solution-storing tank 26 via a pipe 32 and a pipe 34. The pipe 32 has one end connected with the solidification bath 24 and the other end connected with the solution-storing tank 26, and a supplying means 30a for supplying the solidification solution 12a from the solidification bath 24 to the solution-storing tank 26 is disposed in the mid-way of the pipe 32. The pipe 34 has one end connected with the solution-storing tank 26 and the other end connected with the solidification bath 24, and is provided with a supplying means 30b for supplying the solidification solution 12a from the solution-storing tank 26 to the solidification bath 24.

As the supplying means 30a or 30b, any means capable of transferring the solidification solution 12a may be used. For example, a pump may be used.

The temperature control means 28 comprises a heating means 28a for heating the solidification solution 12a and a cooling means 28b for cooling the solidification solution 12a.

That is, the temperature control means 28 uses the heating means 28a and the cooling means 28b to directly heat or cool the solidification solution 12a in the solution-storing tank 26, so the temperature of the solidification solution 12a in the solution-storing tank 26 can be controlled.

For the heating means 28a and the cooling means 28b, any means capable of heating or cooling the solidification solution 12a to control the solidification solution 12a to a specified temperature may be used. As a specific example of the solution-storing tank 26 comprising the heating means 28a and the cooling means 28b, a thermostatic bath having a heating function or a cooling function may be used.

In the production apparatus 1, the solidification solution 12a is transferred from the solidification bath 24 to the solution-storing tank 26 via the pipe 32, and the temperature of the solidification solution 12a is controlled in the solution-storing tank 26 to a specified temperature by the temperature control means 28. Then, the solidification solution 12a which has been temperature-controlled is returned from the solution-storing tank 26 back to the solidification bath 24 via the pipe 34 for circulation. Drawing the solidification solution 12a from the solidification bath 24 to the solution-storing tank 26 and then returning the solidification solution 12a which has been temperature-controlled back to the solidification bath 24 for circulation in this way is preferred. This allows for continuous input of the solidification solution 12a which has been temperature-controlled into the solidification bath 24 and, also, an agitating effect attributed to the circulation can be obtained in the solidification bath 24 so that a more precise and uniform temperature control can be achieved.

In the production apparatus 1, a temperature measuring means for measuring the temperature of the solidification solution 12a in the solidification bath 24 of the solidification means 12 is preferably provided to feed back a measurement result so that the temperature of the solidification solution 12a can be controlled by the temperature control means 28. In this way, the fluctuation in the quality of the produced porous film can be easily suppressed. The temperature measuring means may also be disposed in the solution-storing tank 26, but is preferably disposed in the solidification bath 24 as described above because the fluctuation in the quality of the porous film can be more easily suppressed.

Furthermore, in this embodiment, a dry-jet wet-spinning process where an idling zone is disposed between the spinning nozzle 10 and the solidification solution 12a is adopted. However, a wet spinning process that spins directly from the spinning nozzle 10 towards the solidification solution 12a may also be adopted.

The cleaning means 14 is a means that uses a cleaning solution 14a to remove the solvent remaining in the porous hollow-fiber film M through cleaning. The cleaning means 14 in this embodiment receives the cleaning solution 14a into a cleaning bath 14b, and the porous hollow-fiber film M is moved through the cleaning solution 14a so as to be cleaned by the cleaning solution 14a.

Besides the aforesaid implementation of the cleaning means 14, a means typically used to remove the solvent remaining in the porous hollow-fiber film M may also be used as the cleaning means 14. For example, a means in which a cleaning solution flows through an inclined tank-like cleaning bath and the porous hollow-fiber film M is moved through the cleaning solution may also be used.

As the removing means 16, a means typically used to remove the pore former remaining in the porous hollow-fiber film M may be used. For example, it is possible to use a means comprising: a chemical solution retaining part for retaining a chemical solution containing an oxidant in the porous hollow-fiber film M, a thermal decomposition part for heating the porous hollow-fiber film M, in which the chemical solution is retained, in a gas atmosphere to oxidatively decompose the pore former; and a cleaning and removing part for using a cleaning solution to clean the pore former that has been decomposed into a low molecular weight so as to remove the pore former from the porous hollow-fiber film M.

As the chemical solution retaining part, a chemical solution retaining part having a chemical solution tank for receiving the chemical solution may be used so that, by moving the porous hollow-fiber film M through the chemical solution, the chemical solution can be retained in the porous hollow-fiber film M.

As the thermal decomposition part for heating the porous hollow-fiber film M where the chemical solution is retained therein, one using a heating fluid to heat the porous hollow-fiber film M at the atmospheric pressure is preferred. In view of preventing drying of the oxidant such as hypochlorite so that the decomposition can be accomplished efficiently, a thermal decomposition part that uses a fluid having a high relative humidity as the heating fluid and performs heating under humid and hot conditions is more preferred.

As the cleaning and removing part, for example, the implementation described with respect to the cleaning means 14 may be used.

The drying means 18 is used to dry the porous hollow-fiber film M. As the drying means 18, any means capable of adequately drying the porous hollow-fiber film M may be used. For example, a well-known drying device such as a hot air dryer typically used for drying of porous films may be used. In the drying means 18 in this embodiment, the porous hollow-fiber film M is moved continuously reciprocatively in a device capable of circulating the hot air at a speed of about several meters per second so that the porous hollow-fiber film M is dried from the outer periphery.

The winding means 20 may be any means capable of winding the porous hollow-fiber film M onto a bobbin or the like. For example, the used means may have a configuration in which the porous hollow-fiber film M is wound as a guiding element or the bobbin traverses while a tension roll, a torque motor or the like is used to control the tension of the porous hollow-fiber film M.

The guiding members 22 are used to limit the movement of the porous hollow-fiber film M from the solidification means 12 to the cleaning means 14, the removing means 16, the drying means 18 and the winding means 20 in the production apparatus 1. Through disposition of the guiding members 22, the fiber can be prevented from being suspended. Thus, contact of the porous hollow-fiber film M with the interior or the exterior of or with the entrances or exits of the individual means can be prevented.

Members typically used in the production of porous hollow-fiber films may be used as the guiding members 22, examples of which are metal or ceramic guiding members.

A production apparatus according to another embodiment of this invention comprises: a solidification means (also called a “solidification part”) for solidifying the film-forming starting solution in the solidification solution, a cleaning means (also called a “cleaning part”) for removing the solvent remaining in the porous film, and a drying means (also called a “drying part”) for drying the porous film. Additionally, the production apparatus is preferably provided with a temperature control means for controlling the temperature of the solidification solution, and furthermore, a winding means for winding the hollow-fiber film may also be provided.

### (Porous Hollow-Fiber Film Production Apparatus II)

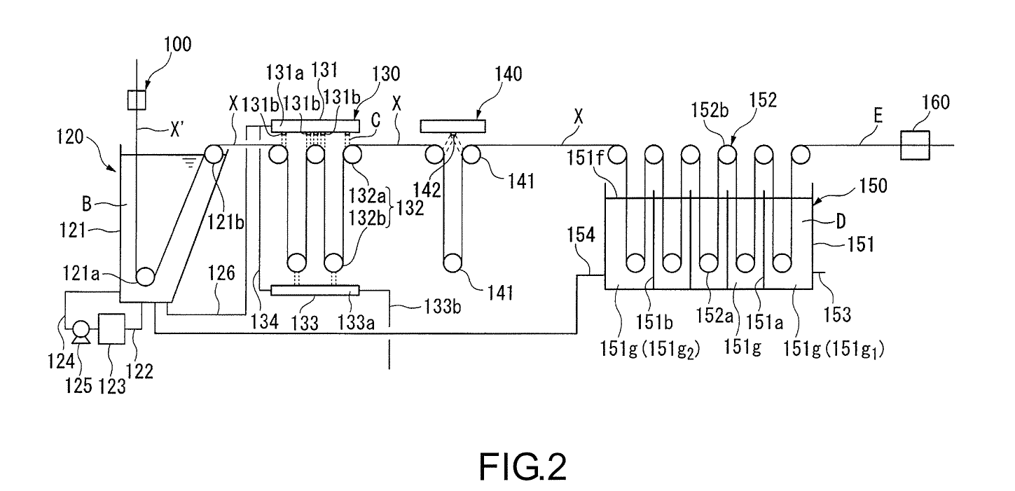

According to the aforesaid production apparatus of another embodiment of this invention, a hollow fiber body with a coating of the film-forming starting solution is immersed into the solidification solution to solidify the coating of the film-forming starting solution, and then the coated hollow fiber body is made porous to produce a hollow-fiber film. Specifically, as shown in FIG. 2, the production apparatus of this embodiment comprises a spinning part 110, a solidification part 120, a filtering means 123, a first cleaning part 130, a transferring part 140, a second cleaning part 150 and a drying part 160.

Further, as shown in FIG. 1, the production apparatus of this embodiment may also comprise the temperature control means 28 and the winding means 20.

(Spinning Part)

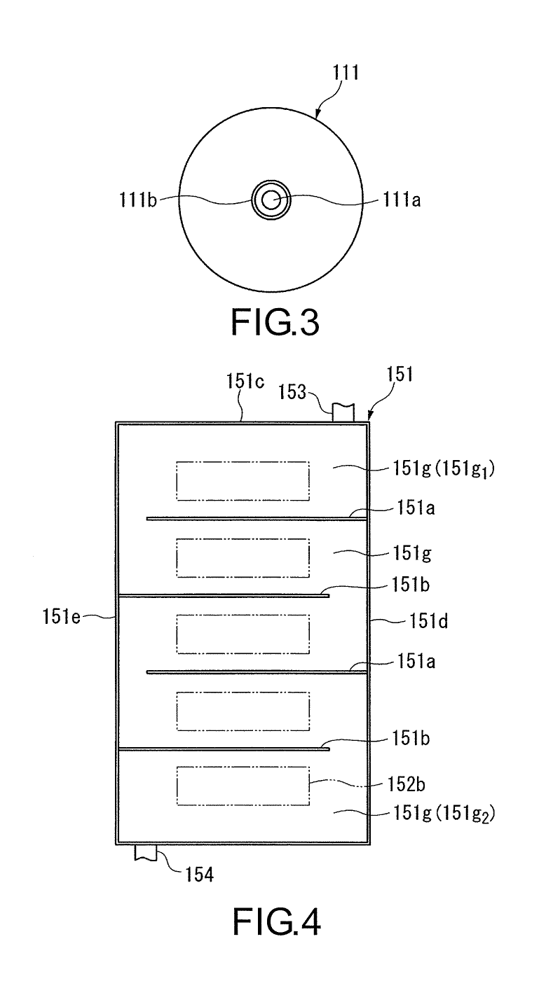

As shown in FIG. 3, the spinning part 110 in this embodiment comprises a spinning nozzle 111, which is formed with a support discharge port 111a for discharging a band-like hollow support and an annular film-forming starting solution spraying port 111b for discharging the film-forming starting solution. The film-forming starting solution spraying port 111b is formed concentrically with the support discharge port 111a at the outer side of the support discharge port 111a.

This kind of spinning nozzle 111 discharges the band-like hollow support from the discharge port 111a and simultaneously discharges the film-forming starting solution from the discharge port 111b, so a coating of the film-forming starting solution is formed on an outer peripheral surface of the band-like hollow support to produce a hollow fiber X′.

(Solidification Part)

The solidification part 120 in this embodiment comprises: a solidification tank (also called a “solidification bath”) 121 for receiving the solidification solution B, a drawing pipe 122 for drawing the solidification solution B from the solidification tank 121, a filtering means 123 for filtering the solidification solution B drawn from the drawing pipe 122, a returning pipe 124 for connecting the filtering means 123 to the solidification tank 121, a pump 125 disposed in the returning pipe 124, and a solidification solution transferring pipe 126 for transferring a part of the solidification solution B from the solidification tank 121 to the first cleaning part 130.

In the solidification tank 121, a first guide roll 121a arranged near the bottom of the solidification tank 121 and a second guide roll 121b arranged inside the solidification tank 121 and near an edge of the solidification tank 121 are provided. The first guide roll 121a is used to wind the fiber body X′, which is obtained from the spinning part 110, in the solidification solution B. The second guide roll 121b is used to draw the hollow fiber X, which is obtained by passing the fiber body X′ through the solidification solution B, out of the solidification tank 121. Furthermore, the second guide roll 121b is disposed in a manner such that a part of the peripheral surface thereof is immersed into the solidification solution B while the remaining part of the peripheral surface is exposed above the liquid level of the solidification solution B. Thus, there is always some solidification solution B attached on the peripheral surface of the second guide roll 121b.

The filtering means 123 comprises a filter for filtering the solidification solution B supplied by the drawing pipe 122. The filtering may be accomplished through any of vacuum filtration, pressure filtration and natural filtration, but the vacuum filtration is preferred because this can not only capture foreign matters by use of a simple device but also accelerate the filtering speed.

The mesh size of the filter preferably ranges from 0.1 μm to 50 μm, and more preferably from 0.5 μm to 30 μm. A mesh size of the filter above the lower limit can accelerate the filtering speed, and a mesh size of the filter below the upper limit helps to capture an increased amount of foreign matters.

In the solidification part 120, the hollow fiber body X′, in which a coating of the film-forming starting solution is formed on the outer peripheral surface of the band-like hollow support, is moved by the first guide roll 121a and the second guide roll 121b so as to be immersed into the solidification solution B of the solidification tank 121, wherein the coating of the film-forming starting solution is solidified by the solidification solution B to obtain the hollow fiber X.

Further, a part of the solidification solution B is transferred via the drawing pipe 122 from the solidification tank 121 to the filtering means 123 for filtering, and the filtrate is returned back to the solidification tank 121 via the returning pipe 124 and the pump 125.

Further, a part of the solidification solution B from the solidification tank 121 is transferred to the first cleaning part 130 via the solidification solution transferring pipe 126.

(First Cleaning Part)

The first cleaning part 130 in this embodiment comprises: a cleaning solution discharge means 131 for discharging a cleaning solution C in a free falling manner, a guiding means 132 disposed below the cleaning solution discharge means 131 to move the hollow fiber X while the hollow fiber X is in contact with the cleaning solution C, a recovery means 133 disposed below the guiding means 132 to recover the cleaning solution C, and a returning pipe 134 for returning the recovered cleaning solution C back to the cleaning solution discharge means 131.

The cleaning solution C used in the first cleaning part 130 is the solidification solution B drawn from the solidification tank 121.

The cleaning solution discharge means 131 in this embodiment comprises a storing tank 131a for storing the cleaning solution C, and a plurality of discharge ports 131b, 131b, . . . for discharging the cleaning solution C vertically downwards. The shape of the discharge ports 131b is not particularly limited. Furthermore, the solidification solution transferring pipe 126 is connected to the storing tank 131a to supply the solidification solution B from the solidification tank 121 for re-use as the cleaning solution C.

The guiding means 132 is used to move the hollow fiber X to contact the falling cleaning solution C.

The guiding means 132 comprises pairs of upper and lower cylindrical rotary bodies 132a and 132b disposed horizontally in the axial direction. The cylindrical rotary bodies 132a and 132b rotate in a manner such that the hollow fiber X is transferred while reciprocating between the cylindrical rotary bodies 132a and 132b.

The length of the cylindrical rotary bodies 132a and 132b or the times that the hollow fiber X reciprocates between the cylindrical rotary bodies 132a and 132b may be appropriately selected according to the concentration of the residual solvent in the hollow fiber X. Preferably, the higher the concentration of the residual solvent is, the more the times of reciprocating will be.

The recovery means 133 accepts and recovers the cleaning solution C that falls from the cleaning solution discharge means 131 and has been used to clean the hollow fiber X.

The recovery means 133 in this embodiment comprises a recovery tank 133a for recovering the cleaning solution C, and an exhaust pipe 133b for exhausting a part of the recovered cleaning solution C out of the hollow-fiber film production device. The recovery means 133 is disposed below the lower cylindrical rotary body 132b.

The returning pipe 134 is used to return a part of the cleaning solution C, which is recovered by the recovery means 133, back to the cleaning solution discharge means 131, and connects the recovery tank 133a to the storing tank 131a.

In the first cleaning part 130, the hollow fiber X is moved by the guiding means 132 while the cleaning solution C falls from the discharge ports 131b of the cleaning solution discharge means 131 so that the hollow fiber X is flushed and cleaned by the cleaning solution C.

Further, the cleaning solution C having been used to clean the hollow fiber X is recovered by the recovery means 133. A part of the recovered cleaning solution C is exhausted out of the hollow-fiber film production apparatus via the exhaust pipe 133b, while the remaining part of the cleaning solution C is returned by the returning pipe 134 back to the storing tank 131a of the cleaning solution discharge means 131 for recycling.

(Transferring Part)

The transferring part 140 applies a force to move the hollow fiber X.

The transferring part 140 in this embodiment comprises a plurality of drive rolls 141, 141, . . . for rotation driving, and a drive roll cleaning means 142 for discharging a good solvent of the hydrophilic polymer towards the drive rolls 141.

The drive rolls 141 are arranged to be parallel with each other in a manner such that a tension force can be applied to the hollow fiber X when the hollow fiber X is wound.

As a specific example of the drive roll cleaning means 142, a nozzle that discharges a good solvent of the hydrophilic polymer in a showering way may be used. Spraying of the good solvent of the hydrophilic polymer may be either continuous or intermittent.

(Second Cleaning Part)

The second cleaning part 150 uses a heated cleaning solution D to clean the hollow fiber X and decomposes the hydrophilic polymer to obtain the hollow-fiber film E.

The second cleaning part 150 in this embodiment comprises: a cleaning tank 151 in which a heated cleaning solution D is received, a guiding means 152 for guiding the hollow fiber X in a manner such that the hollow fiber X is immersed into the heat cleaning solution D many times, a heated cleaning solution supplying pipe 153 for supplying the heated cleaning solution D to the cleaning tank 151, and a heated cleaning solution transferring pipe 154 for transferring the heated cleaning solution D used in the cleaning tank 151 to the solidification tank 121.

In this embodiment, the cleaning tank 151 is in a roughly rectangular cuboidal form, and comprises partitions 151a and 151b that partition the interior of the cleaning tank 151 into a plurality of compartments which allow for the heated cleaning solution D to move. The heated cleaning solution D moves from the downstream side towards the upstream side in the transferring direction of the hollow fiber X. As shown in FIG. 4, the cleaning tank 151 in this embodiment has an opening portion 151c which is in a rectangular form when being viewed from the top, and a plurality of partitions 151a and 151b is vertically installed on a pair of sidewalls (a first sidewall 151d and a second sidewall 151e) of the cleaning tank 151 along a longitudinal direction of the opening portion. The length of the partitions 151a and 151b is shorter than the length between the first sidewall 151d and the second sidewall 151e. Thus, spaces are formed between the partitions 151a and the second sidewall 151e and between the partitions 151b and the first sidewall 151d, respectively. Further, the partitions 151a installed on the first sidewall 151d and the partitions 151b installed on the second sidewalls 151e are arranged alternately.

In such a cleaning tank 151, the heated cleaning solution D serpentines along the partitions 151a and 151b as it moves from the downstream side towards the upstream side in the transferring direction of the hollow fiber X.

The guiding means 152 comprises: lower guide rolls 152a disposed in plural below a liquid level 151f of the heated cleaning solution D of the cleaning tank 151, and upper guide rolls 152b disposed in plural above the liquid level 151f of the heated cleaning solution D. The lower guide rolls 152a are disposed inside the cleaning compartments 151g formed through the partitioning by the partitions 151a and 151b, and the upper guide rolls 152b are disposed above the partitions 151a and 151b.

In the guiding means 152, the hollow fiber X is wound around the lower guide rolls 152a and the upper guide rolls 152b alternately to reverse the moving direction alternately. In this way, the hollow fiber X reciprocates in the vertical direction while it is being moved so that the hollow fiber X is immersed into the heated cleaning solution D and lifted up from the heated cleaning solution D repeatedly. Thus, the hollow fiber X is immersed into the heated cleaning solution D many times.

The heated cleaning solution supplying pipe 153 is installed in the downstream-most cleaning compartment 151g1 in the transferring direction of the hollow fiber X, and the heated cleaning solution transferring pipe 154 is installed in the upstream-most cleaning compartment 151g2 in the transferring direction of the hollow fiber X.

(Drying Part)

The drying part 160 is used to dry the hollow-fiber film E that has been cleaned by the second cleaning part 150. Specifically, a hot air dryer, a vacuum dryer or the like may be used.

A winding means such as a bobbin for winding the hollow-fiber film E may also be disposed at the downstream side of the dryer 160.

(Porous Film Production Method I)

Next, a method for producing a porous film of this invention will be described. The method for producing a porous film of this invention may be either a method of producing a porous film having a porous film layer outside a reinforcing support, or a method of producing a porous film having a porous film layer but without having a reinforcing support. Further, the method for producing a porous film of this invention may be either a method of producing a porous film having a single porous film layer, or a method of producing a porous film having multiple porous film layers. Further, the porous film of this invention may be either a porous hollow-fiber film obtained by using a spinning nozzle as a discharge means for spinning, or a sheet-like or film-like porous flat film.

Hereinafter, a porous hollow-fiber film production method using the production device 1 will be described as an embodiment of the method for producing a porous film of this invention.

The method for producing a porous hollow-fiber film of this embodiment comprises a spinning step, a solidification step, a cleaning step, a removing step, a drying step and a winding step to be described later. The solidification step is characterized in controlling the temperature of the solidification solution.

The spinning step is a step of using the spinning nozzle 10 to spin the film-forming starting solution A.

The solidification step is a step of using the solidification means 12 to solidify the film-forming starting solution A in the solidification solution 12a to form the porous hollow-fiber film M. This step is characterized in controlling the temperature of the solidification solution.

The cleaning step is a step of using the cleaning means 14 to clean the porous hollow-fiber film M to remove the solvent remaining in the porous hollow-fiber film M.

The removing step is a step of using the removing means 16 to remove the pore former remaining in the porous hollow-fiber film M.

The drying step is a step of using the drying means 18 to dry the porous hollow-fiber film M.

The winding step is a step of using the winding means 20 to wind the dried porous hollow-fiber film M.

Spinning Step:

The film-forming starting solution A is discharged from the spinning nozzle 10 for spinning. As the film-forming starting solution A, a film-forming starting solution containing a film-forming resin, a pore former and a solvent is used.

As the film-forming resin, a resin typically used to form a porous film layer of a porous film may be used, for example, a hydrophobic polymer such as a polysulfone resin, a polyether sulfone resin, a sulfonated polysulfone resin, a polyvinylidene fluoride resin, a polyacrylonitrile resin, a polyimide resin, a polyamide imide resin, or a polyester imide resin. These polymers may be appropriately chosen as desired, and the polyvinylidene fluoride resin is particularly preferred because of its superior chemical resistance.

The film-forming resins may be used alone or in a combination of two or more.

As the pore former, polymer resins such as the monool types, the diol types and the triol types represented by polyethylene glycol, and polyvinyl pyrrolidone may be used, for example. These resins may be appropriately chosen as desired, and a hydrophilic polymer is preferred because, by degassing and agitating the hydrophilic polymer together with a hydrophobic polymer, a porous film layer having a three-dimensional (3D) network structure can be preferably formed after solidification. Among the polymer resins, polyvinyl pyrrolidione is particularly preferred because of its superior tackifying effect.

These pore formers may be used alone or in a combination of two or more.

The solvent is not particularly limited so long as it can dissolve both the film-forming resin and the pore former. For example, dimethyl sulfoxide, N,N-dimethyl acetamide, or dimethyl formamide may be used.

These solvents may be used alone or in a combination of two or more.

Additionally, in addition to the pore former, other additives may also be used as any ingredients in the film-forming starting solution A used herein provided that the additives will not interfere with controlling of the phase separation.

On the basis of the film-forming starting solution A (100 mass %), the percentage of the film-forming resin is preferably 10 mass % or above and more preferably 15 mass % or above because this can improve the stability during the film formation and make it easy to form a superior porous film structure. Furthermore, for the same reason, the percentage of the film-forming resin is preferably 30 mass % or below and more preferably 25 mass % or below. In other words, the percentage of the film-forming resin is preferably 10 to 30 mass % and more preferably 15 to 25 mass %.

On the basis of the film-forming starting solution A (100 mass %), the percentage of the pore former is preferably 1 mass % or above and more preferably 5 mass % or above because this makes it easy to form the porous hollow-fiber film M. Furthermore, in view of operability of the film-forming starting solution A, the percentage of the pore former is preferably 20 mass % or below and more preferably 12 mass % or below. In other words, the percentage of the pore former is preferably 1 mass % to 20 mass % and more preferably 5 mass % to 12 mass %.

Solidification Step:

By immersing the film-forming starting solution A that has been spun by the spinning nozzle 10 into the solidification solution 12a received in the solidification bath 24 of the solidification means 12, the film-forming starting solution A is solidified to form the porous hollow-fiber film M.

By immersing the film-forming starting solution A into the solidification solution 12a, the solidification solution 12a diffuses in the film-forming starting solution A. As a result, the film-forming resin and the pore former are phase separated and solidified respectively to form a porous film layer having a 3D network structure in which the film-forming resin and the pore former are mixed with each other. In this stage, it is speculated that the pore former in a gel state are intertwined with the film-forming resin three-dimensionally.

The temperature of the film-forming starting solution A for spinning is preferably 20° C. to 40° C.

The solidification solution 12a must be a solvent that will not dissolve the film-forming resin and that is a good solvent of the pore former. As the solidification solution 12a, water, ethanol, methanol or the like, or a mixture thereof may be used. In view of operational environment and operation management, a mixture of the solvent used in the film-forming starting solution A and water is particularly preferred.

This invention is characterized in that, the solidification solution which has been temperature-controlled by the temperature control means in the solution-storing tank is transferred to the solidification means to control the temperature of the solidification solution used in the solidification step. Specifically, in this embodiment, the solidification solution 12a received in the solidification bath 24 is transferred and drawn by the pipe 32 to the solution-storing tank 26 where the solidification solution 12a is heated or cooled by the heating means 28a or the cooling means 28b to control the temperature of the solidification solution 12a. Then, the solidification solution 12a is returned by the pipe 34 from the solution-storing tank 26 back to the solidification bath 24 for recycling.

As compared with the conventional method of indirectly controlling the temperature of the solidification solution by controlling the temperature of the warm water circulating in the jacket portion, directly controlling the temperature of the solidification solution 12a in the solution-storing tank 26 as described above can reduce the amplitude of fluctuation of the temperature of the solidification solution 12a with the time. Thereby, fluctuation in the quality such as water permeability (water filter (WF)) and surface aperture of the obtained porous film can be suppressed. Moreover, a method of circulating the solidification solution 12a to control the temperature is preferred because this allows for continuous input of the temperature-controlled solidification solution into the solidification bath and can also provide an agitating effect in the solidification bath attributed to the circulation so that a more precise and uniform temperature control can be achieved.

On the basis of the solution amount stored in the solidification tank, the amount of the solidification solution transferred from the temperature control means to the solidification means per minute is preferably 30% to 70%. An amount of 30% or above allows for precise temperature adjustment in the solidification tank. However, once the amount exceeds 70%, turbulence may be generated in the solidification tank. Furthermore, because a gap exists when the flow from the temperature control means to the solidification means decreases, a non-uniform temperature distribution may be generated in the solidification tank.

The liquid transferred from the temperature control means to the solidification tank is preferably transferred by a pipe having an inner diameter ranging from 10 mm to 30 mm. If the inner diameter ranges from 10 mm to 30 mm, a good balance between the heat dissipation from the pipe leading from the temperature control means to the solidification means and the pressure loss can be achieved.

Furthermore, the length of the pipe preferably ranges from 500 mm to 20000 mm. If the length ranges from 500 mm to 20000 mm, a good balance between the heat dissipation from the pipe leading from the temperature control means to the solidification tank means and the pressure loss can be achieved.

Further, the temperature of the liquid transferred from the temperature control means to the pipe is preferably 1° C. to 5° C. higher than that of the solidification bath. If the temperature of the liquid is 1° C. to 5° C. higher than that of the solidification bath, the temperature of the solidification solution will not drop in the pipe. Thereby, the temperature control of the solidification bath can be achieved.

The temperature of the solidification solution 12a in the solidification step is preferably controlled to be within the range of 60° to 90° C. That is, preferably the specified temperature is set within this range, and the solidification solution 12a is controlled to the specified temperature to produce the porous hollow-fiber film M.

Additionally in the solidification step at an initial stage of producing the porous film of this invention, the solidification solution at the aforesaid temperature is used as the solidification solution in the solidification bath in view of the operation efficiency.

In the method for producing a porous film of this invention, the fluctuation amplitude of the temperature of the solidification solution is preferably suppressed to be within ±1° C. of the preset specified temperature. This makes it easy to suppress the fluctuations in the qualities such as the water permeability (WF) and the surface aperture of the obtained porous film.

Further, in the method for producing a porous film of this invention, preferably the temperature of the solidification solution used in the solidification step is measured in the process and the measurement result is fed back to control the temperature of the solidification solution. This makes it easy to suppress the fluctuation in the quality of the porous film. In this embodiment, the temperature of the solidification solution is preferably measured in the solidification tank 24 because this makes it easy to suppress the fluctuation in the quality of the porous film.

Furthermore, in this embodiment, a dry-jet wet-spinning process where an idling zone is disposed between the spinning nozzle 10 and the solidification solution 12a is adopted. However, this invention is not limited to this, and a wet spinning process that spins the film-forming starting solution A in the solidification solution 12a directly without disposing an idling zone may also be adopted.

Cleaning Step:

The pore former or the solvent will remain in the solution state in the porous hollow-fiber film M formed through the solidification step. Particularly, if the pore former remains in the film, it may be impossible for the porous hollow-fiber film M to provide adequate water permeability. Moreover, if the pore former becomes dried in the film, it will cause degradation in the mechanical strength of the film. On the other hand, if there is solvent remaining in the porous hollow-fiber film M when an oxidant is used to oxidatively decompose the pore former (into a low molecular weight) in the subsequent removing step, a reaction of the solvent with the oxidant will take place to impede the oxidative decomposition of the pore former. Therefore, in this embodiment, the solvent remaining in the porous hollow-fiber film M is removed in the cleaning step after the solidification step, and then the pore former remaining in the porous hollow-fiber film M is removed in the removing step.

In the cleaning step, by moving the porous hollow-fiber film M in the cleaning solution 14a received in the cleaning bath 14b of the cleaning means 14, the porous hollow-fiber film M is cleaned by the cleaning solution 14a to remove the solvent remaining in the porous hollow-fiber film M.

The solvent in the porous hollow-fiber film M diffuses from inside the film to the surface of the film and then diffuses from the surface of the film into the cleaning solution 14a. Thus, the solvent is removed from the porous hollow-fiber film M.

As the cleaning solution 14a, water is preferred because of its desirable cleaning effect. As the water used, the tap water, industrial water, river water, well water or the like water may be used. Furthermore, alcohols, inorganic salts, oxidants, surfactants or the like may also be mixed in the water. Also, as the cleaning solution 14a, a mixture of the solvent contained in the film-forming starting solution and water may be used. When such a mixture is used, the concentration of the solvent is preferably 10 mass % or below.

The temperature of the cleaning solution 14a is preferably 50° C. or above and more preferably 80° C. or above. This can increase the diffusing speed of the solvent in the porous hollow-fiber film M. In view of preventing concentration of the polymer due to volatilization of the solvent or preventing application of excessive energy, the temperature of the cleaning solution 14a is preferably 100° C. or below and more preferably 95° C. or below. In other words, the range of 50° C. to 100° C. is preferred, and the range of 80° C. to 95° C. is more preferred.

Additionally, in the cleaning step, mainly the solvent is removed from the porous hollow-fiber film M. However, by cleaning the porous hollow-fiber film M, a part of the pore former is also removed.

Removing Step:

In the removing step, the pore former remaining in the porous hollow-fiber film M is removed by the removing means 16.

As the removing step, for example, the following step may be used. The porous hollow-fiber film M is immersed into a chemical solution containing an oxidant so that the chemical solution is retained in the porous hollow-fiber film M. The porous hollow-fiber film M is heated in a gas atmosphere to oxidatively decompose the pore former. Then, the porous hollow-fiber film M is cleaned to remove the pore former that has been decomposed into a low molecular weight.

As the oxidant, a hypochlorite, ozone, hydrogen peroxide, a permanganate, a dichromate, a persulfate or the like may be used. Among them, the hypochlorite is more preferred in view of the superior decomposability due to strong oxidizability, the superior operability and the low cost thereof. As the hypochlorite, sodium hypochlorite, calcium hypochlorite or the like may be used, and sodium hypochlorite is particularly preferred. In view of operability, these oxidants are preferably used as the chemical dissolved in the solvent. As the solvent, any solvent well known to exhibit a high solubility may be used, but the solvent is preferably used in the form of an aqueous solution.

In view of easily suppressing oxidative decomposition of the pore former, which remains in the porous hollow-fiber film M, in the chemical solution and easily suppressing further oxidative decomposition of the pore former detached into the chemical solution to cause waste of the oxidant, the temperature of the chemical solution is preferably 50° C. or below and more preferably 30° C. or below. Further, in view of reducing the cost of controlling the chemical solution to a low temperature, the temperature of the chemical solution is preferably 0° C. or above and more preferably 10° C. and above. In other words, the temperature of the chemical solution preferably ranges from 0° C. to 50° C. and more preferably between 10° C. and 30° C.

For heating of the porous hollow-fiber film M having the chemical solution retained therein, a heating fluid at the atmospheric pressure is preferably used.

In view of suppressing drying of the oxidant so that the decomposition can be accomplished efficiently, a fluid having a high relative humidity is preferably used as the heating fluid; i.e., the heating is performed under humid and hot conditions. In this case, the relative humidity of the heating fluid is preferably 80% or above, more preferably 90% or above, and particularly preferably near 100%.

In order to shorten the processing time during continuous processing, the heating temperature is preferably 50° C. or above and more preferably 80° C. or above. Further, the heating temperature is preferably 100° C. or below at the atmospheric pressure. In other words, the heating temperature preferably ranges from 50° C. to 100° C. and more preferably from 80° C. to 100° C.

As the method of removing the pore former that has been decomposed into a low molecular weight, a method of cleaning the porous hollow-fiber film M is preferred. The cleaning method is not particularly limited, and the cleaning methods described in the cleaning step may be used.

Drying Step:

The porous hollow-fiber film M is dried by the drying means 18.

As the method of drying the porous hollow-fiber film M, methods typically used to dry porous hollow-fiber films may be used. For example, a method of using hot air to dry the porous hollow-fiber film M may be used. Specifically, the following method may be used, for example. The porous hollow-fiber film M is moved continuously and reciprocatively in a device capable of circulating the hot air at a speed of about several meters per second so that the porous hollow-fiber film M is dried from the outer periphery.

Winding Step:

The dried porous hollow-fiber film M is wound by the winding means 20.

In the method and the apparatus for producing a porous film of this invention described above, the solidification solution which has been temperature-controlled in the solution-storing tank is transferred to the solidification means to control the temperature of the solidification step. Therefore, as compared with the conventional method of indirectly controlling the temperature of the solidification solution by controlling the temperature of warm water circulating in the jacket portion, the temperature of the solidification solution can be controlled more precisely. Thereby, the fluctuation in the quality such as the water permeability (WF) and the surface aperture of the obtained porous film can be suppressed. Particularly, in the method and the apparatus for producing a porous film of this invention, the temperature of the solidification solution used in the solidification step can also be controlled to be within ±5° C. of the specified temperature, so the fluctuation in the quality of the obtained porous film can be further suppressed.

Additionally, the apparatus for producing a porous film of this invention is not limited to the above apparatus 1. For example, a method of using a T die instead of a spinning nozzle as the discharge means to produce a porous flat film may also be used.

Furthermore, apart from transferring the solidification solution which has been temperature-controlled to the solidification means to control the temperature of the solidification step, other well-known methods and apparatuses may also be used in the method and the apparatus for producing a porous film of this invention.

(Porous Hollow-Fiber Film Production Method II)

Hereinafter, an embodiment of a hollow-fiber film production method that uses the porous hollow-fiber film production apparatus II will be described.

This production embodiment comprises a spinning step, a solidification step, a first cleaning step, a transferring step, a second cleaning step and a drying step, and is characterized in that the solidification solution is filtered in the solidification step.

[Spinning Step]

In the spinning step, a hollow fiber body X′ is produced by discharging a band-like hollow support from the support discharge port 111a of the spinning nozzle 111 and, simultaneously, discharging a film-forming starting solution from the film-forming starting solution discharge port 111b to form a coating of the film-forming starting solution on an outer peripheral surface of the band-like hollow support.

As the band-like hollow support used in this embodiment, a braided band or a knitted band may be used. As fibers for forming the braided band or the knitted band, synthetic fibers, semi-synthetic fibers, recycled fibers, natural fibers or the like may be used. Further, the fibers may be any of monofilament fibers, multifilament fibers and spun yarns.

The film-forming starting solution usually contains a hydrophobic polymer, a hydrophilic polymer and a solvent that can dissolve these polymers. The film-forming starting solution may also contain other additive ingredients as desired.

As the hydrophobic polymer, polysulfone-based resins such as polysulfone and polyether sulfone, fluorine-based resins such as polyvinylidene fluoride, polyacrylonitrile, cellulose derivatives, polyamide, polyester, polymethacrylate, polyacrylate or the like may be used. Also, copolymers thereof may be used. These hydrophobic polymers may be used alone or in a combination of two or more.

In consideration of the superior endurance to oxidants such as hypochlorous, the fluorine-based resins are preferred among the above hydrophobic polymers, and polyvinylidene fluoride or copolymers comprising polyvinylidene fluoride and other monomers are more preferred.

The hydrophilic polymer is added to adjust the viscosity of the film-forming starting solution into a range suitable for forming the hollow fiber X, so as to stabilize the film-forming conditions. Preferably, polyethylene glycol and polyvinyl pyrrolidone are used. In view of controlling the aperture of the obtained hollow-fiber film or the strength of the hollow-fiber film, polyvinyl pyrrolidone or copolymers in which other monomers are polymerized in polyvinyl pyrrolidone are particularly preferred.

Further, two or more resins may be used in mixture in the hydrophilic polymer. For example, if a polymer having a higher molecular weight is used as the hydrophilic polymer, there is a trend that a hollow-fiber film having an excellent film structure can be formed easily. On the other hand, in view of removing the hydrophilic polymer from the hollow fiber X more easily in the hydrophilic polymer removing step described later, a hydrophilic polymer of a low molecular weight is preferred. Therefore, hydrophilic polymers of the same kind but having different molecular weights may be used in mixture as desired.

As the solvent, N,N-dimethyl formamide, N,N-dimethyl acetamide, dimethyl sulfoxide, N-methyl-2-pyrrolidinone, N-methylmorpholine-N-oxide or the like may be used. One or more of these solvents may be used. Moreover, poor solvents of the hydrophobic polymers or the hydrophilic polymers may also be used, provided that they will not compromise the solubility of the hydrophobic polymer or the hydrophilic polymer in the solvent.

The temperature of the film-forming starting solution is not particularly limited, and usually ranges from 20° C. to 40° C.

Either an overly low or an overly high concentration of the hydrophobic polymer in the film-forming starting solution will degrade the stability during the film formation to make it difficult to obtain a target hollow-fiber film. Therefore, the lower limit of the concentration is preferably 10 mass % and more preferably 15 mass %, and the upper limit is preferably 30 mass % and more preferably 25%. In other words, the concentration of the hydrophobic polymer in the film-forming starting solution preferably ranges from 10 mass % to 30 mass % and more preferably from 15 mass % to 25 mass %.

On the other hand, in order to form the hollow-fiber film more easily, the lower limit of the concentration of the hydrophilic polymer is preferably 1 mass % and more preferably 5 mass %. In view of the operability of the film-forming starting solution, the upper limit of the concentration of the hydrophilic polymer is preferably 20 mass % and more preferably 12 mass %. In other words, the concentration of the hydrophilic polymer preferably ranges from 1 mass % to 20 mass % and more preferably from 5 mass % to 12 mass %.

[Solidification Step]

In the solidification step, the coating of the film-forming starting solution formed on the outer peripheral surface of the band-like hollow support is solidified to obtain the hollow fiber X.

Specifically, the fiber body X′ formed with the coating of the film-forming starting solution is transferred towards the first guide roll 121a within the solidification tank 121 containing the solidification solution B, and after the transferring direction is reversed by the first guide roll 121a, the fiber body X′ is moved in the solidification solution B. When the coating of the film-forming starting solution is in contact with the solidification solution B, the solidification solution B diffuses into the film-forming starting solution. Consequently, phase separation of the hydrophobic polymer and the hydrophilic polymer takes place, so the hydrophobic polymer is solidified. In this way, a 3D network structure in which the hydrophobic polymer and the gelatinous hydrophilic polymer are intertwined together is formed on the outer peripheral surface and within the film, thus forming the hollow fiber X.

The hollow fiber X obtained through solidification is transferred out of the solidification tank 121 by the second guide roll 121b.

Further, in the solidification step, a part of the solidification solution B is transferred from the solidification tank 121 via the drawing pipe 122 to the filtering means 123 to be filtered by the filtering means 123. Then, the filtrate obtained through filtering is returned by the pipe 124 and the pump 125 back to the solidification tank 121. The foreign matters captured by the filtering means 123 are exhausted out of the filtering means 123.

Further, in the solidification step, a part of the solidification solution B in the solidification tank 121 is transferred by the solidification solution transferring pipe 126 to the storing tank 131a of the first cleaning part 130.

The solidification solution B is a non-solvent of the hydrophobic polymer and a good solvent of the hydrophilic polymer, and water, ethanol, methanol or the like, or a mixture thereof may be used as the solidification solution B. However, in consideration of the safety and operational management, a mixture of the solvent used in the film-forming starting solution and water is particularly preferred.

Additionally, it is preferred that the solidification solution B, which has been temperature-controlled by the temperature control means 28 (the temperature control means is omitted in FIG. 2) for controlling the temperature of the solidification solution, is transferred to the solidification part 120 to control the temperature of the solidification solution B in the solidification step.

[First Cleaning Step]

In the first cleaning step, as the cleaning solution C in the storing tank 131a falls from the discharge port 131b of the cleaning solution discharge means 131, the hollow fiber X is moved by the guiding means 132 to move reciprocatively between the cylindrical rotary bodies 132a, 132b. Then, the cleaning solution C is attached onto the hollow fiber X, and the solvent remaining in the hollow fiber X diffuses towards the cleaning solution C. As the cleaning solution C attached flows down along the hollow fiber X, mainly the solvent is removed from the hollow fiber X. Thus, the hollow fiber X is cleaned. Furthermore, in this step, a part of the hydrophilic polymer may also be detached from the hollow fiber X in some cases.

Furthermore, the cleaning solution C that has been used to clean the hollow fiber X falls into the recovery tank 133a of the recovery means 133. A part of the recovered cleaning solution C is exhausted, while the remaining pat of the cleaning solution C is returned by the returning pipe 134 back to the storing tank 131a of the cleaning solution discharge means 131 for recycling.

[Transferring Step]

In the transferring step, the hollow fiber X is wound around the individual drive rolls 141 for rotation driving so that a tension force is applied to drive the hollow fiber X to move.

Furthermore, in the transferring step, a good solvent of the hydrophilic polymer is discharged in a showering way from the drive roll cleaning means 142 to clean the drive rolls 141.

[Second Cleaning Step]

In the second cleaning step, the hollow fiber X is immersed into the heated cleaning solution D in the cleaning tank 151 repeatedly to clean the hollow fiber X. In this step, the hydrophilic polymer is decomposed, cleaned and detached so that a hollow-fiber film E having a 3D network structure formed of the hydrophobic polymer is obtained.

Specifically, the heated cleaning solution is supplied via the heated cleaning solution supplying pipe 153 to the cleaning compartment 151g1 of the cleaning tank 151. The heated cleaning solution serpentines in the cleaning tank 151 partitioned by the partitions 151a, 151b as it moves from the cleaning compartment 151g1 towards the cleaning compartment 151g2. Then, the heated cleaning solution D for cleaning is transferred out of the cleaning compartment 151g2 of the cleaning tank 151 into the solidification tank 121 via the heated cleaning solution transferring pipe 154.

Meanwhile, the hollow fiber X is transferred by passing through the lower guide rolls 152a and the upper guide rolls 152b alternately. In this way, the hollow fiber X is immersed into the heated cleaning solution D and lifted up from the heated cleaning solution D repeatedly so that the hollow fiber X is cleaned by the heated cleaning solution D to obtain the hollow-fiber film E.

As the heated cleaning solution D, water is preferred because of its desirable cleaning effect. As the water used, the tap water, industrial water, river water, well water or the like water may be used. Furthermore, alcohols, inorganic salts, oxidants, surfactants or the like may also be mixed in the water. Also, as the heated cleaning solution D, a mixture of the solvent contained in the film-forming starting solution and the water may be used. When such a mixture is used, the concentration of the solvent is preferably 10 mass % or below.

In order to prevent decrease in the diffusion speed of the solvent remaining in the hollow fiber X, a high temperature of the heated cleaning solution D is desired. The temperature of the heated cleaning solution D is preferably 50° C. or above and more preferably 80° C. or above. Further, if the heated cleaning solution D is boiled up while the cleaning is carried out, the outer surface of the hollow fiber X can also be scrubbed by the bubbling generated due to the boiling, so efficient cleaning can be achieved.

[Drying Step]

The method used for the drying step is not particularly limited, and hot air drying, vacuum drying or the like may be applied thereto. After the drying step, the dried hollow-fiber film E may also be wound onto a winding means such as a bobbin.

(Effects)

In the aforesaid embodiment, the solidification solution B is drawn from the solidification tank 121 and filtered by the filtering means 123 to remove foreign matters from the solidification solution B, so defects induced by the foreign matters in contact with the hollow fiber X can be prevented.

Further, the hollow fiber X moves through the second guide roll 121b, so the solidification solution B attached on the hollow fiber X is transferred to the second guide roll 121b and falls from the second guide roll 121b back into the solidification tank 121. This can ease the cleaning load of the first cleaning part 130 and the second cleaning part. Moreover, because a part of the peripheral surface of the second guide roll 121b is immersed into the solidification solution B, the peripheral surface of the second guide roll 121b can be cleaned through rotation. In the first cleaning part 130, the hollow fiber X is cleaned by the cleaning solution C discharged from the cleaning solution discharge means 131 to remove the hydrophilic polymer or the solvent used in the film-forming starting solution from the hollow fiber X. Particularly, because the cleaning solution C is discharged from the cleaning solution discharge means 131 in a freely falling way, the amount of energy necessary for the discharge can be reduced.

Further, in the transferring part 140, the drive rolls 141 are cleaned by the drive roll cleaning means 142, so the hollow fiber X can be transferred smoothly. That is, the hydrophilic polymer detached from the hollow fiber X in the first cleaning step may be re-attached on the drive rolls 141 easily, but by discharging a good solvent of the hydrophilic polymer from the drive roll cleaning means 142 onto the drive rolls 141 for cleaning, attachment and deposition of the hydrophilic polymer can be suppressed. Thereby, transferring of the hollow fiber X is made smooth.

In the second cleaning part 150, the hollow fiber X is cleaned by the heated cleaning solution D to further remove the hydrophilic polymer or the solvent used in the film-forming starting solution from the hollow fiber X. Particularly, the lower guide rolls 152a and the upper guide rolls 152b are used in the second cleaning part 150 to immerse the hollow fiber X into the heated cleaning solution D repeatedly. Thereby, the cleanability of the hollow fiber X can be further improved.

Further, in the second cleaning part 150, the heated cleaning solution D moves from the downstream side towards the upstream side in the transferring direction of the hollow fiber X. The closer to the downstream side of the hollow fiber X, the less the fouling in the heated cleaning solution D will be. Therefore, the hollow fiber X can be cleaned efficiently by the heated cleaning solution D. Further, through disposition of the partitions 151a and 151b, the heated cleaning solution D flows in a serpentine way to result in a prolonged detention time, so more of the heated cleaning solution D can make contact with the hollow fiber X.

Further, in the aforesaid embodiment, the heated cleaning solution D for cleaning in the second cleaning part 150 is re-used as the solidification solution B in the solidification part 120 and the solidification solution B drawn from the solidification tank 121 is re-used as the cleaning solution C in the first cleaning part 130, so the amount of exhausted water containing a high concentration of BOD can be reduced.

### Other Embodiments

Additionally, this invention is not limited to the above embodiments.

For example, in the aforesaid embodiments, a porous film layer is formed on an outer peripheral surface of the reinforcing band-like hollow support. However, it is also possible that only the porous film is formed without existence of the band-like hollow support. In this case, the support discharge port 111a shown in FIG. 3 becomes unnecessary. Alternatively, the support discharge port 111a may also be used as a discharge port of, for example, the internal solidification solution. Furthermore, in case only the porous film is formed, the porous film may be either a monolayer film or a composite porous film formed by replacing the spinning nozzle 111 shown in FIG. 3 with a bi-circular spinning nozzle to form multiple porous film layers simultaneously.

Further, in the solidification part, the second guide roll may also be disposed above the liquid level of the solidification solution.

In the first cleaning part, it is also possible for the cleaning solution not to contact with the hollow fiber by falling from the cleaning solution discharge means. For example, the cleaning solution may alternatively be discharged onto side surfaces of the hollow fiber. Moreover, not returning a part of the recovered cleaning solution back to the cleaning solution discharge means is also possible. Further, the cleaning solution used in the first cleaning part may also not be the solidification solution transferred from the solidification tank, but may be a fresh cleaning solution. The ingredients of the cleaning solution may be identical to those of the cleaning solution used in the second cleaning part.

In the transferring part, it is also possible that the drive roll cleaning means is not provided to clean the drive rolls.

In the second cleaning part, it is also possible that the cleaning tank is not partitioned by the partitions. Moreover, it is also possible that the hollow fiber is not repeatedly immersed into the heated cleaning solution but is immersed only once. Further, the heated cleaning solution may also move from the upstream side towards the downstream side in the transferring direction of the hollow fiber. Further, the heated cleaning solution used in the second cleaning part may also not be transferred to the solidification tank.

Further, it is also possible that this invention does not comprise the first cleaning part, the transferring part and the second cleaning part.

### EXAMPLES

This invention will be detailed below with reference to examples thereof, without being limited by the following descriptions.

### Example 1

The porous hollow-fiber film production apparatus 1 illustrated in FIG. 1 was used to produce a porous hollow-fiber film as follows.

29.7 kg of polyvinylidene fluoride (PVDF) (produced by Arkema Co., Ltd., tradename: PVDF301F) for use as the film-forming resin, 15.6 kg of polyvinyl pyrrolidone (PVP) (by Japan Catalyst Co., Ltd., tradename: PVP-K79) for use as the pore former and 112.2 L of dimethyl acetamide (DMAc) (by Samsung Fine Chemical Co., Ltd.) for use as the solvent were mixed to prepare a first film-forming starting solution. Also, 19 kg of PVDF (by Arkema Co., Ltd., tradename: PVDF301F) for use as the film-forming resin, 18 kg of PVP (by Japan Catalyst Co., Ltd., tradename: PVP-K79) for use as the pore former and 103.3 L of DMAc (by Samsung Fine Chemical Co., Ltd.) for use as the solvent were mixed to prepare a second film-forming starting solution. The first film-forming starting solution was used to form an interior porous hollow-fiber film layer, while the second film-forming starting solution was used to form an exterior porous hollow-fiber film layer.

A braided band (made by Mitsubishi Rayon Co., Ltd., type: M1205) was used as the reinforcing hollow support, the spinning nozzle 10 maintained at a temperature of 32° C. was used to spin by coating the first film-forming starting solution and the second film-forming starting solution on the exterior of the reinforcing support, and then in the solidification solution 12a (8 mass % of DMAc aqueous solution) which is temperature-controlled to 80° C. by the temperature control means 28, the film-forming starting solution was solidified to form a porous hollow-fiber film M. The spinning speed (the moving speed of the porous hollow-fiber film M) was set to be 20 m/minute. The temperature of the solidification solution 12a in the solidification bath 24 was measured by a digital thermometer (made by SATO KEIRYOKI MFG. Co., Ltd., SK-1250MCIIIα) during the production process. The results revealed that the temperature fluctuated between 79.5° C. and 80.5° C.

Then in the cleaning means 14, the porous hollow-fiber film M was moved in the cleaning solution 14a (hot water) of 90° C. to remove the solvent remaining in the porous hollow-fiber film M. Subsequently in the removing means 16, the porous hollow-fiber film M was moved in a chemical solution tank, in which an aqueous hypochlorite solution having a concentration of 5% and at a temperature of 20° C. was received, to retain the chemical solution into the porous hollow-fiber film M, and then the porous hollow-fiber film M was heated at a temperature of 100° C. and a relative humidity of 100% for 3 minutes to decompose the pore former into a low molecular weight. The pore former decomposed into a low molecular weight was removed by the water at 60° C.

Then in the drying means 18, the porous hollow-fiber film M was moved multiple times through a device where hot air at a temperature of 120° C. was circulated at a speed of 3 m/s to dry the porous hollow-fiber film M. Finally, the porous hollow-fiber film M was wound around the winding means 20.

The obtained porous hollow-fiber film had an outer diameter of about 2.8 mm, an inner diameter of about 1.1 mm, a film thickness of 900 μm, and a thickness of the porous layer from the braided band to the surface of 400 μm.

### Comparative Example 1

The following apparatus for producing a porous hollow-fiber film was used to control the solidification solution to a temperature of 80° C., and the porous hollow-fiber films were produced in the same way as Example 1. The porous hollow-fiber film production apparatus had the same structure as the production apparatus 1 except that it did not have the solution-storing tank 26 and the temperature control means 28 but had the solidification means, and the solidification means controlled the temperature of the solidification solution in the solidification bath by controlling the temperature of warm water circulating in a jacket portion of the solidification bath. The temperature of the solidification solution in the solidification bath was measured by a digital thermometer (made by SATO KEIRYOKI MFG. Co., Ltd., SK-1250MCIIIα) during the production process. The results revealed that the temperature fluctuated between 78° C. and 82° C.

The obtained porous hollow-fiber films had an average outer diameter of 2.8 mm, an average inner diameter of 1.1 mm, a film thickness of 900 μm, and a thickness of the porous layer from the braided band to the surface of 400 μm.

[Evaluation Method]

Quality of the porous hollow-fiber films produced in these examples was evaluated in the follow way. By means of a process comprising the following steps (1) to (5), five mini modules were fabricated from the porous hollow-fiber films produced in the same production process (the porous hollow-fiber films were produced continuously under specified conditions without stopping the production apparatus), and bubble points of the mini modules were measured.

### (Fabrication Method of the Mini Modules)

(1) A cap was installed at a foot portion of the porous hollow-fiber film having an effective length of about 4 cm.

(2) 52 mass % of Coronate 4403 (produced by Japan Polyurethane Industrial Co., Ltd.) and 48 mass % of Nippollan 4423 (produced by Japan Polyurethane Industrial Co., Ltd.) were mixed and agitated with a spatula for use as a bonding agent.

(3) The mixed bonding agent was dripped at the foot portion of the cap.

(4) The porous hollow-fiber film was put into a dryer at a temperature of 40° C. for 3 hours to cure the bonding agent.

(5) A front end of the porous hollow-fiber film was sealed by a bonding agent obtained in the same way as (2), and the porous hollow-fiber film was put into the dryer at a temperature of 40° C. in the same way as (4) to cure the bonding agent.

### (Measurement Method of the Bubble Point)

The bubble point was measured in accordance with JIS K 3832 by using ethanol as a measurement medium. The value of the bubble point is an index of the maximum aperture of a porous hollow-fiber film, and the greater this value is, the smaller the maximum aperture will be. If the pore former has a good cleanability (removability), then generation of such defects such as fine cracks on the film surface can be suppressed and, as a result, the bubble point becomes higher.

The evaluation results of bubble points of the porous hollow-fiber films obtained in these examples are shown in Table 1. Additionally, the maximum values, the minimum values and the average values of the bubble points shown in Table 1 all refer to the maximum values, the minimum values and the average values of the measurement values of the five mini modules.

TABLE 1

| | | | Comparative |
|---|---|---|---|
| | | Example 1 | Example 1 |
| Temperature setting of the solidification bath | | 80 | 80 |
| [° C.] | | | |
| Temperature fluctuation | Lowest temperature | 79.5 | 78.0 |
| | [° C.] | | |
| | Highest temperature | 80.5 | 82.0 |
| | [° C.] | | |
| Bubble point [kPa] | Average | 180 | 120 |
| | Minimum | 160 | 80 |
| | Maximum | 200 | 200 |

The qualities of the porous hollow-fiber films obtained in the examples were evaluated. The results revealed that, the porous hollow-fiber films obtained in Comparative Example 1 had a lower bubble point on average, and as compared to the porous hollow-fiber films obtained in Example 1, the difference between the maximum value and the minimum value was larger (i.e., the fluctuation in the quality was larger).

### INDUSTRIAL APPLICABILITY

According to this invention, porous film production method and apparatus capable of suppressing fluctuation in the quality of the obtained porous film by stably controlling the temperature of the solidification solution can be provided. Further, a porous film production apparatus capable of producing a porous film without causing damage thereto can be provided.

### DESCRIPTION OF REFERENCE CHARACTERS

1: Porous film production apparatus
10: Spinning nozzle
12: Solidification means (solidification part)
12a: Solidification solution
14: Cleaning means (cleaning part)
14a: Cleaning solution
16: Removing means (removing part)
18: Drying means (drying part)
20: Winding means
22: Guiding member
24: Solidification bath
26: Solution-storing tank
28: Temperature control means
28a: Heating means
28b: Cooling means
30a, 30b: Supplying means
32, 34: Pipe
A: Film-forming starting solution
M: Porous hollow-fiber film
110: Spinning part
111: Spinning nozzle
111a: Support discharge port
111b: Film-forming starting solution discharge port
120: Solidification part
121: Solidification tank (solidification bath)
121a: First guide roll
121b: Second guide roll
122: Drawing pipe
123: Filtering means
124: Returning pipe
125: Pump
126: Solidification transferring pipe
130: First cleaning part
131: Cleaning solution discharge means
131a: Storing tank
131b: Discharge port
132: Guiding means
132a, 132b: Cylindrical rotary body
133: Recovery means
133a: Recovery tank
133b: Exhaust pipe
134: Returning pipe
140: Transferring part
141: Drive roll
142: Drive roll cleaning means
150: Second cleaning part
151: Cleaning tank
151a, 151b: Partition
151c: Opening portion
151d: First sidewall
151e: Second sidewall
151f: Liquid level
151g, 151g1, 151g2: Cleaning compartment
152: Guiding means
152a: Lower guide roll
152b: Upper guide roll
153: Heated cleaning solution supplying pipe
154: Heated cleaning solution transferring pipe
160: Drying part
X: Hollow fiber
X′: Fiber body
B: Solidification solution
C: Cleaning solution
D: Heated cleaning solution
E: Hollow-fiber film (porous hollow-fiber film)

1. A method for producing a porous film, comprising a solidification step for solidifying a film-forming starting solution in a solidification solution,
wherein a temperature of the solidification solution used in the solidification step is controlled by transferring the solidification solution, which is temperature-controlled by a temperature control means, to a solidification means for solidifying the film-forming starting solution.

2. The method of claim 1, wherein the temperature of the solidification solution is measured in a solidification bath for solidifying the film-forming starting solution in the solidification means, and a result of the measurement is fed back to control the temperature of the solidification solution in a solution-storing tank.

3. The method of claim 2, wherein the solidification solution is drawn from the solidification means for solidifying the film-forming starting solution, and after the temperature of the solidification solution is controlled in the solution-storing tank, the solidification solution is returned back to the solidification means for recycling.

4. The method of claim 3, wherein the solidification means is a solidification bath, and an amount of the solidification solution transferred from the temperature control means to the solidification means per minute is 30% to 70% of a solution amount stored in the solidification bath.

5. The method of claim 4, wherein the solidification solution transferred from the temperature control means is transferred to the solidification bath via a pipe having an inner diameter of 10 mm to 30 mm.

6. The method of claim 5, wherein the pipe has a length of 500 mm to 20000 mm.

7. The method of claim 5, wherein the temperature of the liquid transferred from the temperature control means to the pipe is 1° C. to 5° C. higher than the temperature of the solidification bath.

8. An apparatus for producing a porous film, comprising:
a solidification means for solidifying a film-forming starting solution in a solidification solution;
a supplying means for supplying the solidification solution to the solidification means; and
a temperature control means for controlling a temperature of the solidification solution.

9. The apparatus of claim 8, wherein the solidification means has a solidification bath for solidifying the film-forming starting solution, and a temperature measuring means for measuring the temperature of the solidification solution in the solidification bath, and a measurement result from the temperature measuring means is fed back so that the temperature of the solidification solution is controlled by the temperature control means.

10. The apparatus of claim 8, wherein the solidification solution is drawn from the solidification means to a solution-storing tank, and after the temperature of the solidification solution is controlled in the solution-storing tank, the solidification solution is returned by the supplying means back to the solidification means for recycling.

11. The apparatus of claim 8, comprising a filtering means disposed outside of the solidification bath to filter the solidification solution.

12. The apparatus of claim 11, wherein in the solidification bath, a guide roll for guiding a hollow fiber obtained through solidifying the film-forming starting solution to outside of the solidification bath is disposed in a manner such that a part of a peripheral surface of the guide roll is immersed in the solidification solution while a remaining part of the peripheral surface is exposed above a liquid level of the solidification solution.
